(19) United States
(12) Patent Application Publication
(10) Pub. No.: US 2025/0130449 A1
(43) Pub. Date: Apr. 24, 2025

(54) ELECTRO-OPTICAL COMPONENT AND OPTICAL MODULATION COMPONENT

(71) Applicant: TDK CORPORATION, Tokyo (JP)

(72) Inventors: Kenji SASAKI, Tokyo (JP); Takashi KIKUKAWA, Tokyo (JP); Shusaku UMEMOTO, Tokyo (JP)

(73) Assignee: TDK CORPORATION, Tokyo (JP)

(21) Appl. No.: 18/918,299

(22) Filed: Oct. 17, 2024

(30) Foreign Application Priority Data
Oct. 23, 2023 (JP) 2023-181570

(51) Int. Cl. G02F 1/035; G02F 1/21; G02F 1/225

(52) U.S. Cl. CPC G02F 1/035; G02F 1/212; G02F 1/225

(57) ABSTRACT

An electro-optical component includes: a single crystal substrate; an optical waveguide made of a dielectric thin film formed in contact with a main surface of the single crystal substrate; and an electrode configured to apply voltage to the optical waveguide, wherein the dielectric thin film is made of a lithium niobate film that is an epitaxial film with a c-axis orientation, and a c-axis length of the lithium niobate film is 13.88 Å or more.

### CROSS-REFERENCES TO RELATED APPLICATIONS

This application relies for priority upon Japanese Patent Application No. 2023-181570 filed on Oct. 23, 2023, the entire content of which is hereby incorporated herein by reference for all purposes as if fully set forth herein.

### BACKGROUND

The present disclosure relates to an electro-optical component and an optical modulation component.

Lithium niobate (LiNbO₃, hereinafter sometimes referred to as “LN”) has a large electro-optic constant and is therefore suitable as a material for electro-optical components. Electro-optical components using LN single crystal substrates have excellent high-frequency response characteristics and have been used in devices such as optical modulators and optical switches.

Conventionally, as an electro-optical component using an LN single crystal substrate, there is an optical modulation component having an optical waveguide formed by diffusing Ti (titanium) near the surface of an LN single crystal substrate.

However, such an optical modulation component has a large cross-sectional shape of the optical waveguide, and the electric field efficiency is poor. For this reason, an optical modulator having an optical modulation component using an LN single crystal substrate has a long total length of about 10 cm.

In recent years, there has been a demand for miniaturization of electro-optical components. As a small electro-optical component, there is an optical modulation component having an optical waveguide made of an LN film epitaxially grown on a single crystal substrate. In such an optical modulation component, good electric field efficiency can be obtained by reducing the cross-sectional shape of the optical waveguide, so that it is possible to significantly reduce the size.

For example, Patent Document 1 discloses an optical waveguide component having a waveguide made of a lithium niobate film, which is an epitaxial film formed on a single crystal substrate, and a ridge portion having a ridge-shaped cross section.

### PRIOR ART DOCUMENTS

### Patent Documents

Patent Document 1: JP 2015-230466 A

### SUMMARY

An optical modulation component having an optical waveguide made of an LN film epitaxially grown on a single crystal substrate can be significantly smaller than an optical modulation component having an optical waveguide made by diffusing Ti (titanium) near the surface of an LN single crystal substrate.

However, the optical modulation components having an optical waveguide made of an LN film epitaxially grown on a single crystal substrate have a large DC drift.

In an optical modulation component having an optical waveguide made of an LN film epitaxially grown on a single crystal substrate, the modulation waveform moves depending on the DC (direct current) voltage applied to the electrodes of the optical modulation component. The modulation waveform in an optical modulation component using an LN film changes over the time that the DC (direct current) voltage is applied. This change in the modulation waveform over time is called DC drift.

The present disclosure has been made in consideration of the above problems, and aims to provide an electro-optical component that has an optical waveguide made of a lithium niobate film epitaxially grown on a substrate, and in which DC drift is suppressed.

An electro-optical component according to one aspect of the present disclosure includes: a single crystal substrate; an optical waveguide made of a dielectric thin film formed in contact with a main surface of the single crystal substrate; and an electrode configured to apply voltage to the optical waveguide, wherein the dielectric thin film is made of a lithium niobate film that is an epitaxial film with a c-axis orientation, and a c-axis length of the lithium niobate film is 13.88 Å or more.

The electro-optical component of the present disclosure has an optical waveguide made of a dielectric thin film formed in contact with the main surface of a single crystal substrate, the dielectric thin film being made of a lithium niobate film that is an epitaxial film with a c-axis orientation, and the c-axis length of the lithium niobate film is 13.88 Å or more. This results in an electro-optical component in which DC drift is suppressed when a voltage is applied to the optical waveguide by the electrodes.

### BRIEF DESCRIPTION OF THE DRAWINGS

FIG. 1 is a plan view showing a Mach-Zehnder type optical modulation component 200A which is an example of an electro-optical component of the present disclosure.

FIG. 2A is a cross-sectional view of the optical modulation component 200A shown in FIG. 1 taken along line A-A′.

FIG. 2B is a cross-sectional view of the optical modulation component 200A shown in FIG. 1 taken along the line BB′.

FIG. 3 is a process diagram for explaining a method for manufacturing the optical modulation component 200A shown in FIGS. 1, 2A and 2B, and is a cross-sectional view showing a substrate 1 with a dielectric thin film.

FIG. 4 is a graph showing the relationship between the c-axis length and stress of the lithium niobate film in the multiple dielectric thin film-coated substrates 1 of Experimental Example 1.

FIG. 5 is a graph showing the relationship between the c-axis length of the lithium niobate film on the substrate 1 with the dielectric thin film used in the optical modulation component 200A of Experimental Example 2 and the DC drift after one hour of the optical modulation component 200A of Experimental Example 2.

FIG. 6 is a graph showing the relationship between the application time of a DC voltage and DC drift in the optical modulation component 200A of Experimental Example 2.

### DETAILED DESCRIPTION

In order solve the problem, the present inventors have studied to suppress DC drift when a voltage is applied to an electro-optical component having an optical waveguide made of a lithium niobate film epitaxially grown on a single crystal substrate. Specifically, the present inventors have determined that an electro-optical component is acceptable if the DC drift when heated to 120° C. is 50% or less when the application time of a DC (direct current) voltage reaches 1 hour, and have conducted intensive studies focusing on the relationship between the c-axis length of the lithium niobate film forming the optical waveguide and the DC drift.

As a result, it was found that by forming an electro-optical component having an optical waveguide made of a lithium niobate film having an epitaxial film with a c-axis orientation and a c-axis length of 13.88 Å or more, it is possible to suppress DC drift when a voltage is applied to the optical waveguide. Although the reason why the DC drift of the electro-optical component is suppressed has not been clearly elucidated, it is presumed that this is because the lithium niobate film having a c-axis length of 13.88 Å or more has a sufficiently large compressive stress, so that microscopic gaps are unlikely to form between crystals in the in-plane direction and cracks are unlikely to occur.

More specifically, the inventors have investigated the relationship between the c-axis length of the lithium niobate film epitaxially grown on a single crystal substrate and the stress of the lithium niobate film. It has been conventionally believed that the stress of the lithium niobate film used as an optical waveguide is better as it is closer to 0. However, as a result of the studies, it has been found that the lithium niobate film with a c-axis length of 13.88 Å or more has compressive stress. In addition, it has been found that if the c-axis length of the lithium niobate film is less than 13.88 Å, it may have tensile stress, and the smaller the c-axis length is, the greater the tensile stress tends to be.

The crystal lattice in the lithium niobate film epitaxially grown on the single crystal substrate tries to maintain a constant volume. Therefore, the lithium niobate film with a large c-axis length has a small a-axis length, and the lithium niobate film with a small c-axis length has a large a-axis length. The c-axis length of the lithium niobate single crystal in the bulk state is about 13.864 Å, which is less than 13.88 Å.

From these facts, in the lithium niobate film having a c-axis length of 13.88 Å or more, the a-axis length is in a small state, and the lithium niobate film is trying to expand in the a-axis direction. As a result, the lithium niobate film having a c-axis length of 13.88 Å or more has a compressive stress. On the other hand, in the lithium niobate film having a c-axis length of less than 13.88 Å, the a-axis length is likely to be in a large state, and the lithium niobate film is likely to have a stress that compresses in the a-axis direction. As a result, the lithium niobate film having a c-axis length of less than 13.88 Å has a lack of compressive stress or has a tensile stress. Therefore, in the lithium niobate film having a c-axis length of less than 13.88 Å, microscopic gaps are likely to be formed between the crystals in the in-plane direction, and cracks are likely to occur. From these facts, it is estimated that in an electro-optical component having an optical waveguide made of a lithium niobate film, which is an epitaxial film with a c-axis orientation with a c-axis length of less than 13.88 Å, DC drift becomes large when a voltage is applied to the optical waveguide.

Furthermore, the inventors have confirmed that in an electro-optical component having an optical waveguide made of a lithium niobate film having a c-axis length of 13.88 Å or more epitaxially grown on a single crystal substrate, DC drift can be suppressed when a voltage is applied to the optical waveguide, and have reached tot the present disclosure.

The present disclosure includes the following aspects.

[1] An electro-optical component including:
a single crystal substrate;
an optical waveguide made of a dielectric thin film formed in contact with a main surface of the single crystal substrate; and
an electrode configured to apply voltage to the optical waveguide,
wherein the dielectric thin film is made of a lithium niobate film that is an epitaxial film with a c-axis orientation, and
a c-axis length of the lithium niobate film is 13.88 Å or more.

[2] In the electro-optical component according to [1], the c-axis length of the lithium niobate film may be 13.92 Å or less.

[3] In the electro-optical component according to [1], the single crystal substrate may be a sapphire single crystal substrate, the main surface of which is a c-plane.

[4] An optical modulation component comprising the electro-optical component according to any one of [1] to [3].

The electro-optical component and the optical modulation component of the present embodiment will be described in detail below with reference to the drawings as appropriate. The drawings used in the following description may show characteristic parts enlarged for the sake of convenience in order to make the features of the present disclosure easier to understand. Therefore, the dimensional ratios of each component may differ from the actual ones. The materials, dimensions, etc. exemplified in the following description are merely examples, and the present disclosure is not limited thereto, and may be appropriately modified and implemented within the scope of the present disclosure.

### [Optical Modulation Component]

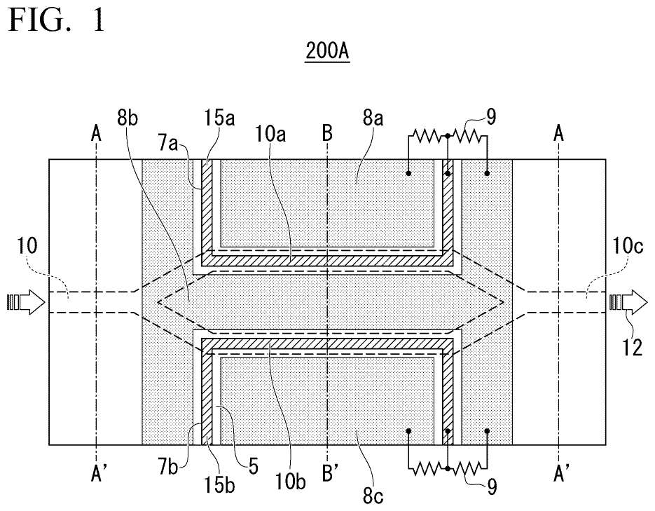

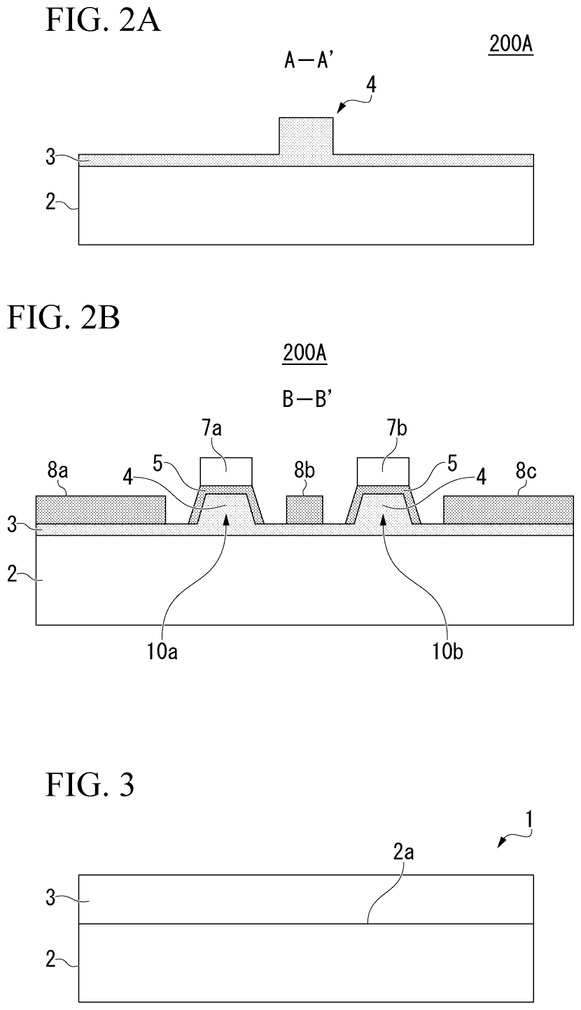

FIG. 1 is a plan view showing a Mach-Zehnder type optical modulation component 200A, which is an example of an electro-optical component of the present disclosure. FIG. 2A is a cross-sectional view of the optical modulation component 200A shown in FIG. 1 taken along line A-A′, and FIG. 2B is a cross-sectional view of the optical modulation component 200A shown in FIG. 1 taken along line B-B′.

The optical modulation component 200A shown in FIGS. 1, 2A and 2B has a single crystal substrate 2, an optical waveguide 10 consisting of a dielectric thin film 3 formed on and in contact with the main surface of the single crystal substrate 2, and electrodes (first electrodes 7a, 7b, second electrodes 8a, 8b, 8c) that apply a voltage to the optical waveguide 10.

### (Single Crystal Substrate 2)

The single crystal substrate 2 may be any known single crystal substrate as long as it is capable of growing an epitaxial film made of an LN film with a c-axis orientation. For example, a sapphire single crystal substrate or a silicon single crystal substrate may be used as the single crystal substrate 2.

In the optical modulation component 200A of this embodiment, the single crystal substrate 2 preferably has a lower refractive index than LN. It is particularly preferable to use a sapphire single crystal substrate as the single crystal substrate 2. The sapphire single crystal substrate has a lower refractive index than LN. For this reason, for example, when the dielectric thin film 3 is used as the optical waveguide layer 10, it can play the role of a cladding layer. Therefore, when the single crystal substrate 2 is a sapphire single crystal substrate, the dielectric thin film 3 can be suitably used as the optical waveguide layer 10 of the optical modulation component 200A without providing a separate cladding layer between the single crystal substrate 2 and the dielectric thin film 3.

When a silicon single crystal substrate is used as the single crystal substrate 2, it is necessary to provide a layer between the single crystal substrate 2 and the dielectric thin film 3, the refractive index of which is lower than that of LN, since the refractive index of silicon is higher than that of LN.

In the optical modulation component 200A of this embodiment, the dielectric thin film 3 is made of an LN film, which is an epitaxial film oriented along the c-axis, and has three-fold symmetry. Therefore, it is desirable that the crystal orientation of the main surface (the surface on the dielectric thin film 3 side) of the single crystal substrate 2 has the same symmetry as that of the dielectric thin film 3. Therefore, when a sapphire single crystal substrate is used as the single crystal substrate 2, for example, it is preferable that the main surface is a c-plane. Furthermore, when a silicon single crystal substrate is used as the single crystal substrate 2, for example, it is preferable that the main surface is a (111) plane. The single crystal substrate 2 may have an off-angle.

In the optical modulation component 200A of this embodiment, the dielectric thin film 3 formed on the single crystal substrate 2 is likely to be formed as an epitaxial film with a c-axis orientation for single crystal substrates 2 of various crystal orientations. Therefore, in the optical modulation component 200A of this embodiment, the crystal orientation of the single crystal substrate 2 is not particularly limited.

### (Dielectric Thin Film 3)

The dielectric thin film 3 is made of an LN film, which is an epitaxial film oriented along the c-axis. Since LN has a large electro-optic constant, it is suitable as a material for the optical waveguide layer 10 of the optical modulation component 200A.

The LN film depositing the dielectric thin film 3 may contain elements such as K, Na, Rb, Cs, Be, Mg, Ca, Sr, Ta, Ba, Ti, Zr, Hf, V, Cr, Mo, W, Fe, Co, Ni, Zn, Sc, Ce, and the like.

The LN film depositing the dielectric thin film 3 is preferably a single phase consisting of LiNbO₃ phase. The LN film depositing the dielectric thin film 3 may contain abut in order to obtain good characteristics, it is preferable that the LN film does not contain a different phase such as LiNb₃O₈ phase or Li₃NbO₄ phase.

In the optical modulation component 200A of this embodiment, the dielectric thin film 3 is made of an LN film that is an epitaxial film with a c-axis orientation, and the c-axis length is 13.88 Å or more. In the optical modulation component 200A of this embodiment, the c-axis length of the LN film is 13.88 Å or more, so that DC drift is suppressed when a voltage is applied to the optical waveguide 10. The c-axis length of the LN film is preferably 13.89 Å or more in order to obtain the optical modulation component 200A with even more suppressed DC drift.

The LN film in the optical modulation component 200A of this embodiment preferably has a c-axis length of 13.92 Å or less. An LN film having a c-axis length of more than 13.92 Å has a very large compressive stress. As a result, the warping of the single crystal substrate 2 having the epitaxially grown LN film becomes large. As a result of the study by the present inventors, it was found that by making the optical modulation component 200A have an optical waveguide 10 made of an LN film having a c-axis length of 13.92 Å or less, it is possible to suppress the warping of the single crystal substrate 2 having the LN film from interfering with the microfabrication when manufacturing a device using the optical modulation component 200A.

When an LN film is epitaxially grown, it may grow epitaxially in a so-called twin state in which crystals sharing a c-axis are bonded. There is no problem even if the LN film depositing the dielectric thin film 3 in the optical modulation component 200A of this embodiment is a twin crystal.

The optical modulation component 200A shown in FIGS. 1, 2A and 2B is a device that applies a voltage to a Mach-Zehnder interferometer formed by an optical waveguide 10 to modulate the light propagating through the optical waveguide 10. As shown in FIG. 1, the optical waveguide 10 has a first optical waveguide 10a and a second optical waveguide 10b branched from a single input optical waveguide, and an output optical waveguide 10c in which the first optical waveguide 10a and the second optical waveguide 10b are combined.

As shown in FIGS. 1 and 2B, two first electrodes 7a and 7b are provided on the first optical waveguide 10a and the second optical waveguide 10b, respectively. Therefore, the optical modulation component 200A has a dual electrode structure. The first electrodes 7a and 7b may be, for example, an Au film or a laminate of a Ti film and an Au film.

The optical modulation component 200A shown in FIGS. 1, 2A and 2B has a ridge portion 4 formed by processing the dielectric thin film 3 into a ridge shape (convex shape). In the optical modulation component 200A, the ridge portion 4 forms the optical waveguide 10. As shown in FIG. 2B, a first electrode 7a is formed on the ridge portion 4 constituting the first optical waveguide 10a of the optical waveguide 10, via a buffer layer 5. Also, a first electrode 7b is formed on the ridge portion 4 constituting the second optical waveguide 10b of the optical waveguide 10, via a buffer layer 5. As shown in FIG. 2B, the buffer layer 5 is formed so as to cover the upper and side surfaces of the ridge portion 4. The buffer layer 5 can be, for example, an SiO₂ film or a thin film of SiO₂ to which an oxide of a metal element has been added.

As shown in FIGS. 1 and 2B, the second electrodes 8a, 8b, 8c are provided spaced apart from each other via the first electrodes 7a, 7b. The second electrodes 8a, 8b, 8c are formed in contact with the upper surface of the slab portion made of the dielectric thin film 3. The second electrodes 8a, 8b, 8c may be made of, for example, an Au film or a laminated film of a Ti film and an Au film. The first electrodes 7a, 7b and the second electrodes 8a, 8b, 8c apply a voltage that changes the refractive index of the first optical waveguide 10a and the second optical waveguide 10b of the optical waveguide 10 in the in-plane direction from above the dielectric thin film 3.

The slab portion made of the dielectric thin film 3 is formed by thinning a part of the upper surface of the dielectric thin film 3 formed in contact with the main surface of the single crystal substrate 2 by etching or the like.

As shown in FIG. 1, the first electrodes 7a, 7b and the second electrodes 8a, 8b, 8c are connected by a termination resistor 9.

### [Method of Manufacturing Optical Modulation Component]

The optical modulation component 200A shown in FIGS. 1, 2A and 2B can be manufactured, for example, by the manufacturing method shown below. FIG. 3 is a process diagram for explaining the manufacturing method of the optical modulation component 200A shown in FIGS. 1, 2A and 2B, and is a cross-sectional view showing a substrate 1 with a dielectric thin film.

In this embodiment, first, as shown in FIG. 3, a dielectric thin film 3 is formed on the main surface 2a of the single crystal substrate 2 to manufacture a substrate 1 with a dielectric thin film (dielectric thin film formation process). In the dielectric thin film formation process, the dielectric thin film 3 is formed on the main surface 2a of the single crystal substrate 2 by a method of epitaxial growth.

The thickness of the dielectric thin film 3 epitaxially grown on the main surface 2a of the single crystal substrate 2 is preferably 0.2 μm to 2 km. If the thickness of the dielectric thin film 3 is 0.2 μm or more, the dielectric thin film 3 of the substrate 1 with the dielectric thin film is applicable to a wide range of light from visible light to infrared light when used as the optical waveguide layer 10 of the optical modulation component 200A. If the thickness of the dielectric thin film 3 is 2 μm or less, the occurrence of cracks in the LN film depositing the dielectric thin film 3 can be effectively suppressed.

The method for depositing the dielectric thin film 3 may be any method that can cause epitaxial growth on the main surface 2a of the single crystal substrate 2, and for example, a sputtering method, a vacuum deposition method, a pulsed laser ablation (PLD) method, a chemical vapor deposition method (CVD) method, a sol-gel method, etc. can be used.

When sputtering is used as a method for depositing the dielectric thin film 3, a target having a composition in the range of Li/(Li+Nb)=48% to 51%, for example, can be used.

The target can be produced, for example, by the following method. As the raw material, for example, a sintered body mainly composed of Li₂CO₃ and Nb₂O₅ with a purity of 3N or more is prepared. Next, the raw material is pulverized and mixed using a ball mill using balls made of ZrO₂ to obtain a target powder material. The obtained target powder material is sintered using a known method to obtain a target.

In the target manufacturing process, when the raw material is pulverized using the ball mill, the balls made of ZrO₂ are scraped off, and several hundred ppm or less of Zr is mixed into the target. However, since the amount of Zr mixed into the target is small, the dielectric thin film 3 can be epitaxially grown on the main surface 2a of the single crystal substrate 2 by sputtering using the target containing Zr.

There is no particular limitation on the shape of the target used to deposit the dielectric thin film 3. In addition, the target preferably has a planar area twice or more the planar area of the single crystal substrate 2 so that the dielectric thin film 3 having a uniform thickness can be obtained.

When sputtering is used as a method for depositing the dielectric thin film 3, the deposition conditions are, for example, a mixed gas of Ar and O₂ as the sputtering gas, the O₂ ratio in the sputtering gas is set to 20% to 60%, the gas pressure is set to 0.1 Pa to 2 Pa, the temperature of the single crystal substrate 2 is set to 400° C. to 700° C., a power of 500 W to 2000 W is applied, and the deposition rate is set to 2 nm/h to 15 nm/h. This allows the deposition of the dielectric thin film 3 made of an LN film, which is an epitaxial film with a c-axis orientation.

When sputtering is used as a method for depositing the dielectric thin film 3, an LN film having a c-axis length of 13.88 Å or more and 13.92 Å or less can be obtained by appropriately adjusting the above deposition conditions. However, since the situation differs depending on the equipment used when depositing the dielectric thin film 3, even if the above deposition conditions are satisfied, it does not necessarily mean that an LN film having a c-axis length of 13.88 Å or more and 13.92 Å or less can be obtained.

Next, the dielectric thin film 3 in the substrate 1 with the dielectric thin film shown in FIG. 3 is processed into a ridge shape (convex shape) by using a known method such as an etching method, to form an optical waveguide 10 consisting of a ridge portion 4 and a slab portion consisting of the dielectric thin film 3, as shown in FIGS. 2A and 2B.

Next, a buffer layer 5 is formed so as to cover the top and side surfaces of the ridge portion 4 by using a known method such as sputtering, vacuum deposition, pulsed laser ablation (PLD) or chemical vapor deposition (CVD).

Thereafter, using a known method such as sputtering or vacuum deposition, second electrodes 8a, 8b, and 8c are formed in contact with the upper surface of the slab portion made of the dielectric thin film 3, and first electrodes 7a and 7b are formed on the buffer layer 5.

Through the above steps, the optical modulation component 200A shown in FIGS. 1, 2A and 2B is obtained.

### [Operation Principle of Optical Modulation Component]

Next, the operating principle of the optical modulation component 200A will be described.

As shown in FIG. 1, two first electrodes 7a, 7b and second electrodes 8a, 8b, 8c are connected by a termination resistor 9 to function as traveling wave electrodes. The first electrodes 7a, 7b are used as signal electrodes, and the second electrodes 8a, 8b, 8c are used as ground electrodes. So-called complementary signals, which have the same absolute value, different positive and negative phases, and are not shifted, are input to the two first electrodes 7a, 7b from the input sides 15a, 15b of the first electrodes 7a, 7b of the optical modulation component 200A.

In this embodiment, when a signal is input from the input side 15a, 15b, a DC (direct current) voltage is applied in a superimposed manner in the in-plane direction of the dielectric thin film 3 from the first electrodes 7a, 7b toward the second electrodes 8a, 8b, 8c. This causes the refractive indexes of the first optical waveguide 10a and the second optical waveguide 10b of the optical waveguide 10 to change in proportion to the DC voltage, and output light having a modulated waveform is output from the output optical waveguide 10c. The modulated waveform of the output light output from the optical modulation component 200A changes with the application time of the DC (direct current) voltage. This change in the modulated waveform over time is called DC drift.

The LN film forming the dielectric thin film 3 in the substrate 1 with dielectric thin film has an electro-optic effect. Therefore, the refractive indexes of the first optical waveguide 10a and the second optical waveguide 10b change to +Δn and −Δn, respectively, depending on the DC (direct current) voltage applied to the first optical waveguide 10a and the second optical waveguide 10b. As a result, the phase difference between the first optical waveguide 10a and the second optical waveguide 10b changes. Signal light having a modulated waveform that is intensity-modulated by this change in phase difference is output to the output side 12 from the output optical waveguide 10c, where the first optical waveguide 10a and the second optical waveguide 10b are combined.

The optical modulation component 200A of this embodiment shown in FIGS. 1, 2A and 2B has an optical waveguide 10 made of a dielectric thin film 3 formed on the main surface 2a of a single crystal substrate 2, and the dielectric thin film 3 is made of an LN film, which is an epitaxial film with a c-axis orientation, and the c-axis length of the LN film is 13.88 Å or more. Therefore, the optical modulation component 200A is one in which DC drift is suppressed when a DC (direct current) voltage is applied in the in-plane direction from above the optical waveguide 10 by the first electrodes 7a, 7b and the second electrodes 8a, 8b and 8c. Therefore, the optical modulation component 200A of this embodiment has excellent reliability and can be used suitably as an optical communication device, for example.

When the optical modulation component 200A of this embodiment is heated to 120° C. and a signal is input from the input sides 15a and 15b of the first electrodes 7a and 7b, and a DC (direct current) voltage is superimposed and applied from the first electrodes 7a and 7b to the second electrodes 8a, 8b and 8c in the in-plane direction of the dielectric thin film 3, the DC drift is preferably 50% or less when the application time of the DC (direct current) voltage reaches 1 hour. The DC drift is a numerical value calculated using the following formula (I).

DC drift (%)=(shift voltage(V)/applied DC voltage(V))×100 (I)

(In formula (I), the shift voltage (V) is a DC (direct current) voltage that indicates the amount of phase shift (drift amount) of the modulated waveform relative to the modulated waveform at the time when the DC (direct current) voltage is applied.)

When the above DC drift of the optical modulation component 200A of this embodiment when heated to 120° C. is 50% or less when the application time of the DC (direct current) voltage reaches 1 hour, the inventors have determined that this is a characteristic that is sufficiently practical for the device they are considering. This is because the optical modulation component 200A is provided with a feedback driver (control circuit) that controls the DC (direct current) voltage applied from the first electrodes 7a, 7b to the second electrodes 8a, 8b, 8c, and the amount of phase shift of the modulation waveform can be easily compensated for by applying a DC voltage corresponding to the shift voltage (V) using the feedback driver.

Although the preferred embodiment of the present disclosure has been described above, the present disclosure is not limited to the above embodiment. The present disclosure can be modified in various ways without departing from the spirit of the present disclosure, and it goes without saying that such modifications are also included within the scope of the present disclosure.

For example, in the above-described embodiment, an optical modulation component has been described as a preferred example of the electro-optical component of the present disclosure, but the electro-optical component of the present disclosure is not limited to an optical modulation component and may be any electro-optical component that performs operating point control by applying a DC voltage, such as an optical switch.

### EXAMPLE

### Experimental Example 1

Substrates 1 with the dielectric thin film as shown in FIG. 3 were manufactured by the method described below.

First, a 4-inch sapphire single crystal substrate having a c-plane main surface 2a was prepared as the single crystal substrate 2.

### (Dielectric Thin Film Formation Process)

In the dielectric thin film formation step, the dielectric thin film 3 made of an LN film was formed on the main surface 2a of the single crystal substrate 2 by epitaxial growth using a sputtering method.

The target used was a circle having a diameter of 8 inches and a composition of Li/(Li+Nb)=50%.

The target was prepared by the following method. A sintered body mainly composed of Li₂CO₃ and Nb₂O₅ with a purity of 3N or more was prepared as a raw material. Next, the raw material was pulverized and mixed using a ball mill using balls made of ZrO₂ to obtain a target powder. The obtained target powder was sintered to obtain a target.

The dielectric thin film 3 was formed by arranging the target thus obtained coaxially with the single crystal substrate 2 so that the distance from the main surface 2a of the single crystal substrate 2 was 70 mm.

The dielectric thin film 3 was formed by using a mixed gas of Ar and O₂ as the sputtering gas, setting the O₂ ratio in the sputtering gas to 35% to 60%, the gas pressure to 0.1 Pa to 0.5 Pa, setting the temperature of the single crystal substrate 2 to 450° C. to 700° C., and applying a power of 1500 W to 2000 W so that the film formation rate was 2 nm/h to 15 nm/h.

By the above steps, a plurality of substrates 1 with dielectric thin films of Experimental Example 1 were obtained.

For each of the multiple dielectric thin film-attached substrates 1 of Experimental Example 1 obtained in this manner, an out-of-plane 2θ-θ scan was performed using an X-ray diffraction measurement device (manufactured by Rigaku Corporation) to check whether or not they had a c-axis orientation according to the following criteria. As a result, it was confirmed that the dielectric thin film 3 of all of the dielectric thin film-attached substrates 1 of Experimental Example 1 was an epitaxial film having a c-axis orientation.

### Standard

In the 2θ-θ scan of the out-of-plane measurement, the peak of the LN (006) plane, which is c-axis oriented, was strongly observed, and the peak intensity of the LN plane other than the (006) plane was 10% or less of the maximum peak intensity of the (006) plane, so that the LN was deemed to have c-axis orientation.

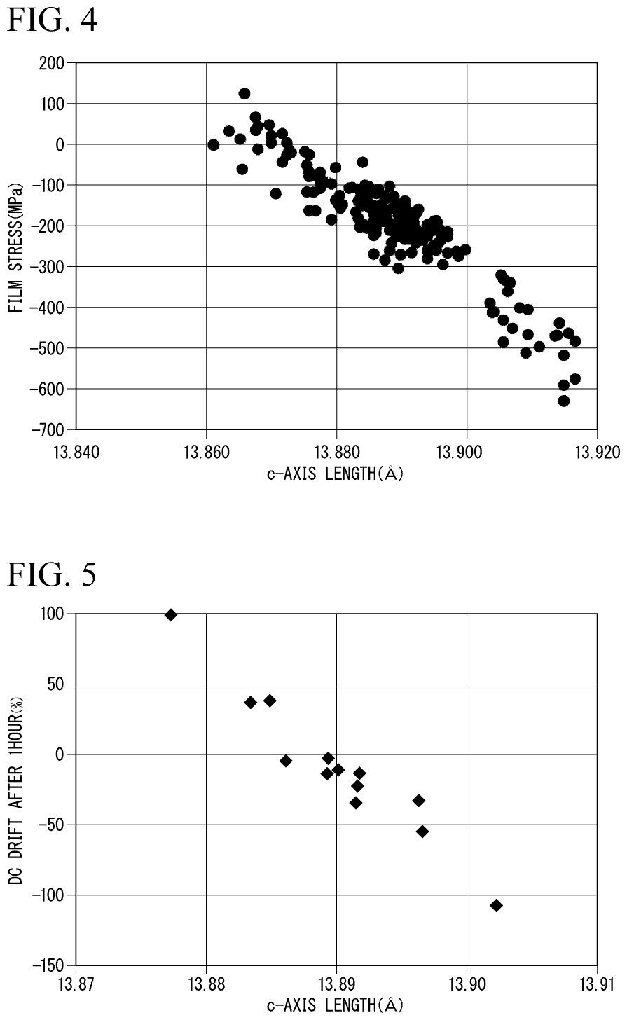

Furthermore, for each of the multiple dielectric thin film-attached substrates 1 in Experimental Example 1, the c-axis length of the LN film and the stress (film stress) of the dielectric thin film 3 made of the LN film were examined by the method described below. The results are shown in FIG. 4.

c-Axis Length

The c-axis length was determined as six times the d value (planar spacing) of LN(006) observed in the 2θ-θ scan of the out-of-plane measurement.

Stress in Thin Dielectric Film The amount of warpage of each of the multiple dielectric thin film-coated substrates 1 in Experimental Example 1 was measured using a needle-type step gauge (manufactured by KLA-Tenchore Corporation), and the stress of the dielectric thin film 3 made of an LN film was calculated using Stoney's formula. When measuring the amount of warpage, the direction was specified so that the calculated stress was positive when it was tensile stress, and negative when it was compressive stress.

FIG. 4 is a graph showing the relationship between the c-axis length and stress of the LN film in the multiple dielectric thin film-coated substrates 1 in Experimental Example 1. When the stress value in FIG. 4 is “plus (+)”, the LN film has tensile stress, and when the stress value in FIG. 4 is “minus (−)”, the LN film has compressive stress.

As shown in FIG. 4, it was confirmed that the LN film in the dielectric thin film-coated substrate 1 having a c-axis length of 13.88 Å or more has compressive stress. Also, as shown in FIG. 4, it was confirmed that the LN film in the dielectric thin film-coated substrate 1 having a c-axis length of 13.92 Å or less has compressive stress of −700 or more, and warpage can be suppressed.

### Experimental Example 2

### [Manufacture of Optical Modulation Component]

Thirteen optical modulation components 200A shown in FIGS. 1, 2A, and 2B were manufactured by the manufacturing method described below using thirteen substrates 1 with dielectric thin films each having a different c-axis length of the LN film selected from the multiple substrates 1 with dielectric thin films in Experimental Example 1.

First, the dielectric thin film 3 on the substrate 1 with the dielectric thin film was processed into a ridge shape (convex shape) by etching to form an optical waveguide 10 consisting of a ridge portion 4, and a slab portion consisting of the dielectric thin film 3.

Next, a buffer layer 5 consisting of a thin film mainly composed of SiO₂ and containing an oxide of In was formed by sputtering so as to cover the top and side surfaces of the ridge portion 4.

Thereafter, a Ti film and an Au film were formed in this order on the upper surface of the slab portion made of the dielectric thin film 3 to become the second electrodes 8a, 8b, and 8c, and a Ti film and an Au film were formed in this order on the buffer layer 5 to become the first electrodes 7a and 7b. Using the obtained Ti film and Au film as seed layers, an Au film was further formed by plating to form the second electrodes 8a, 8b, and 8c and the first electrodes 7a and 7b made of a laminated film of the Ti film and the Au film. Through the above process, 13 pieces of the optical modulation component 200A of the experimental example 2 shown in FIGS. 1, 2A, and 2B were obtained.

### DC Drift Evaluation

The DC drift evaluation was performed on each of the 13 optical modulation components 200A of Experimental Example 2 by the method described below.

That is, the optical modulation component 200A was heated to 120° C., and a signal was input from the input sides 15a and 15b of the first electrodes 7a and 7b. At that time, a DC (direct current) voltage of 8 V was superimposed and applied from the first electrodes 7a and 7b to the second electrodes 8a, 8b and 8c in the in-plane direction of the dielectric thin film 3. Then, for one hour from the time when the DC (direct current) voltage was applied in the in-plane direction of the dielectric thin film 3, the modulated waveform of the output light output from the output optical waveguide 10c of the optical modulation component 200A to the output side 12 was observed by an oscilloscope.

Then, when the application time of the DC voltage reached 1 hour, the DC drift (DC drift after 1 hour) was calculated using the above formula (I) from the phase shift (drift amount) of the modulated waveform relative to the modulated waveform at the time when the DC voltage was applied. The results are shown in FIG. 5.

FIG. 5 is a graph showing the relationship between the c-axis length of the LN film in the substrate 1 with the dielectric thin film used in the optical modulation component 200A of Experimental Example 2 and the DC drift after one hour of the optical modulation component 200A of Experimental Example 2. Those in which the DC drift after one hour in FIG. 5 exceeded 50% were evaluated as failing, and those in which the DC drift was 50% or less were evaluated as passing.

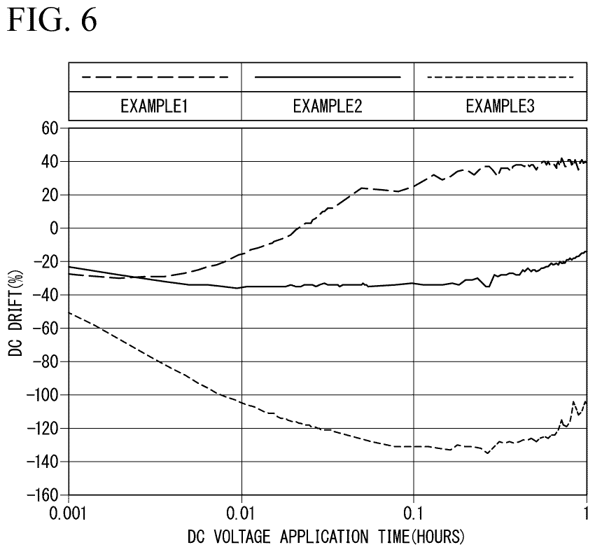

FIG. 6 is a graph showing the relationship between the application time of the DC voltage and the DC drift in the optical modulation component 200A of Experimental Example 2. In Example 1 in FIG. 6, the c-axis length of the LN film in the substrate 1 with the dielectric thin film used in the optical modulation component 200A of Experimental Example 2 is 13.884 Å, in Example 2 the c-axis length is 13.889 Å, and in Example 3 the c-axis length is 13.902 Å.

As shown in FIGS. 5 and 6, the DC drift after one hour was 50% or less for all optical modulation components 200A in which the c-axis length of the LN film was 13.88 Å or more. In contrast, the DC drift after one hour was more than 50% for optical modulation components 200A in which the c-axis length of the LN film was less than 13.88 Å.

From these findings, it has been confirmed that the DC drift can be suppressed by forming the optical waveguide 10 consisting of the dielectric thin film 3 formed on and in contact with the main surface 2a of the single crystal substrate 2 as the optical modulation component 200A, which is made of an LN film that is an epitaxial film with a c-axis orientation and has a c-axis length of 13.88 Å or more.

While preferred embodiments of the invention have been described and illustrated above, it should be understood that these are exemplary of the invention and are not to be considered as limiting. Additions, omissions, substitutions, and other modifications can be made without departing from the scope of the present disclosure. Accordingly, the invention is not to be considered as being limited by the foregoing description, and is only limited by the scope of the appended claims.

### REFERENCE SYMBOL

1 Substrate with dielectric thin film
2 Single crystal substrate
2a Main surface
3 Dielectric thin film
4 Ridge portion
5 Buffer layer
7a, 7b First electrode
8a, 8b, 8c Second electrode
9 Termination resistor
10 Optical waveguide
10a First optical waveguide
10b Second optical waveguide
10c Output optical waveguide
12 Output side
15a, 15b Input side
200A Optical modulation component.

1. An electro-optical component comprising:
a single crystal substrate;
an optical waveguide made of a dielectric thin film formed in contact with a main surface of the single crystal substrate; and
an electrode configured to apply voltage to the optical waveguide,
wherein the dielectric thin film is made of a lithium niobate film that is an epitaxial film with a c-axis orientation, and
a c-axis length of the lithium niobate film is 13.88 Å or more.

2. The electro-optical component according to claim 1, wherein the c-axis length of the lithium niobate film is 13.92 Å or less.

3. The electro-optical component according to claim 1, wherein the single crystal substrate is a sapphire single crystal substrate, the main surface of which is a c-plane.

4. An optical modulation component comprising the electro-optical component according to claim 1.
